(19) United States
(12) Patent Application Publication
(10) Pub. No.: US 2024/0035366 A1
(43) Pub. Date: Feb. 1, 2024

(54) USE OF SELF-ORGANIZING-MAPS WITH LOGGING-WHILE-DRILLING DATA TO DELINEATE RESERVOIRS IN 2D AND 3D WELL PLACEMENT MODELS

(71) Applicant: Halliburton Energy Services, Inc., Houston, TX (US)

(72) Inventor: Arthur Robert Walmsley, London (GB)

(21) Appl. No.: 17/876,025

(22) Filed: Jul. 28, 2022

(51) Int. Cl. E21B 44/00; E21B 49/08

(52) U.S. Cl. CPC E21B 44/005; E21B 49/087; E21B 2200/22; E21B 2200/20

(57) ABSTRACT

The disclosure provides a data clustering process for interpreting formation data, such as delineating reservoirs in well placement models. The data clustering process can be used with correlating offset well data and high angle or horizontal (HAHZ) target well data. Facies distribution and thus stratigraphy and the position of a borehole within the stratigraphic setting can also be assessed using the data clustering process via unsupervised computer learning techniques. A method of performing a well operation associated with a wellbore and an automated directional drilling system are provided herein. In one example, the method includes: (1) obtaining target well data from a wellbore in a subterranean formation, (2) generating a facies cluster model for the subterranean formation using a clustering process on the target well data, and (3) performing a well operation associated with the wellbore using the facies cluster model.

### BACKGROUND

In a geosteering operation of a target well, geologists or directional drillers use petrophysical data from the logging-while-drilling (LWD) or measurement-while-drilling (MWD) logs, such as the gamma-ray, resistivity, density, or porosity logs, and directional drilling data to interpret the target subterranean formation and estimate the borehole position or relative location of the target well in the various layers of the subterranean formation. For example, the LWD/MWD data is often used in placement of a target well and earth modelling software to determine position of a wellbore and the structure, stratigraphy and petrophysical nature of the geology surrounding and/or adjacent to the wellbore. The LWD/MWD logs of the target well are usually compared and correlated with logs of an offset well to interpret the position of the target well and construct a geological model that can be used for drilling. Typically, geologists manually interpret the formation data and correlate the LWD/MWD logs of a target well to the available logs of one more offset wells. From the manual interpretation, steering decisions for the target well can be made based on the understanding of the formation.

### SUMMARY

In one aspect, the disclosure provides a method of performing a well operation associated with a wellbore. In one example, the method includes: (1) obtaining target well data from a wellbore in a subterranean formation, (2) generating a facies cluster model for the subterranean formation using a clustering process on the target well data, and (3) performing a well operation associated with the wellbore using the facies cluster model.

In another aspect, an automated directional drilling system is disclosed. In one example the system has one or more processors to perform operations including: (1) obtaining target well data from a high angle or horizontal (HAHZ) wellbore in a subterranean formation, (2) generating a facies cluster model for the subterranean formation using a clustering process on the target well data, and (3) drilling the HAHZ wellbore steering a drill bit in the subterranean formation using the facies cluster model.

In yet another aspect, the disclosure provides a computer program product having a series of operating instructions stored on a non-transitory computer readable medium that direct operation of one or more processors when initiated thereby to perform operations including: (1) receiving target well data from a wellbore in a subterranean formation, (2) automatically generating a facies cluster model for the subterranean formation using a clustering process on the target well data, and (3) directing a well operation associated with the wellbore using the facies cluster model.

### BRIEF DESCRIPTION

Reference is now made to the following descriptions taken in conjunction with the accompanying drawings, in which:

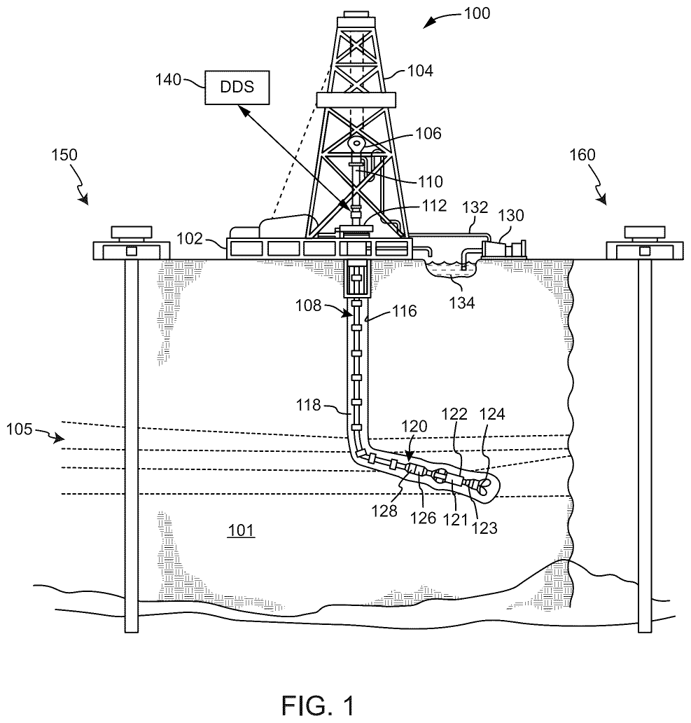

FIG. 1 illustrates an example of a well system that is used to direct a drill bit to drill a wellbore within a subterranean formation according to the principles of the disclosure;

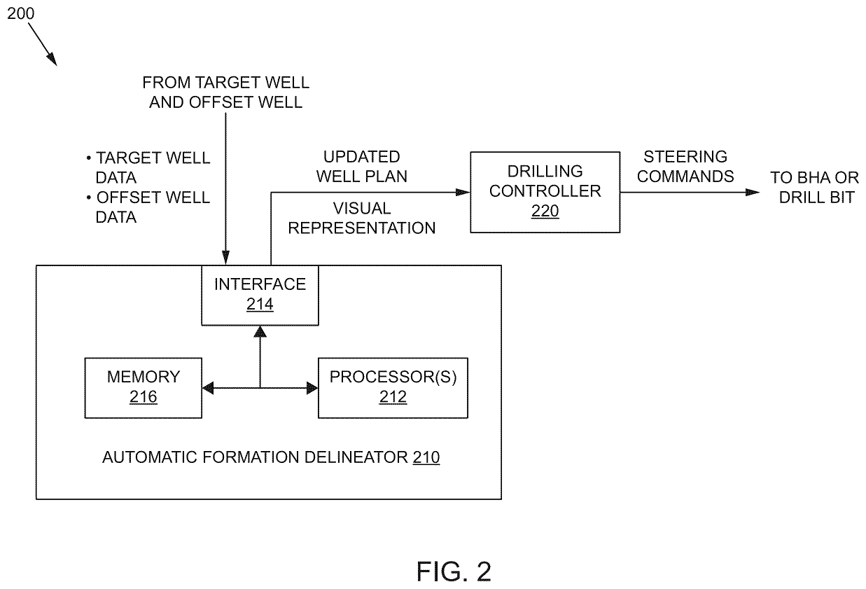

FIG. 2 illustrates a block diagram of an example of a directional drilling system (DDS) constructed according to the principles of the disclosure;

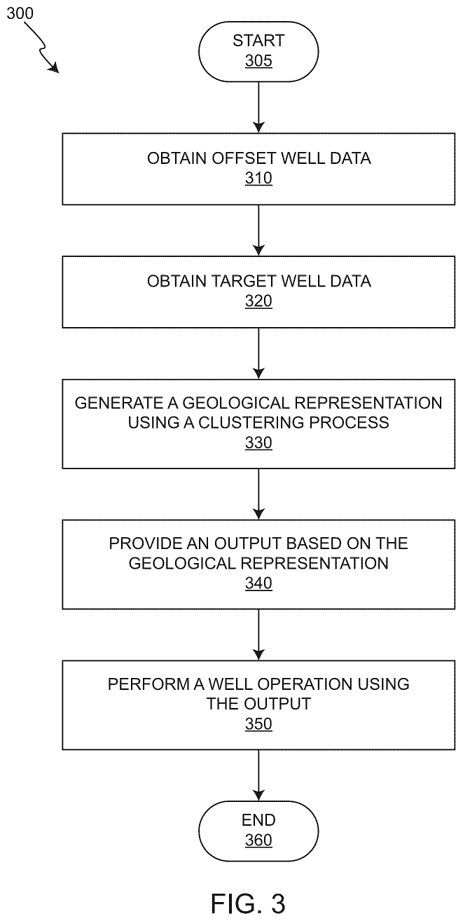

FIG. 3 illustrates a flow diagram of an example of a method of performing a well operation carried out according to the principles of the disclosure;

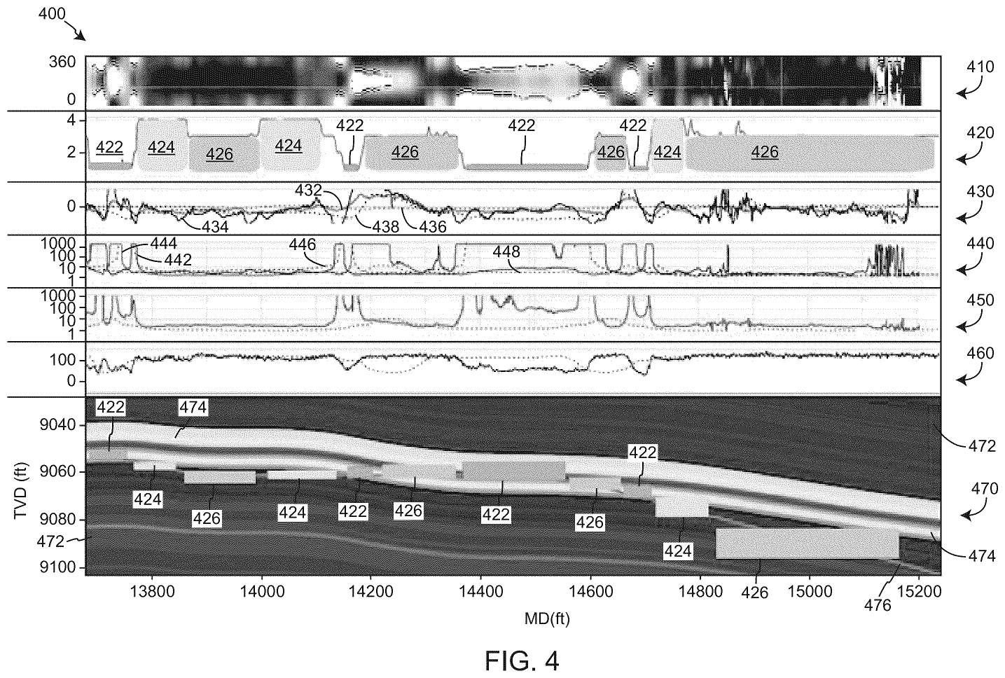

FIG. 4 illustrates an example of a clustering process that uses SOMs as the unsupervised machine learning clustering algorithm to provide an output that is a visual representation according to the principles of the disclosure;

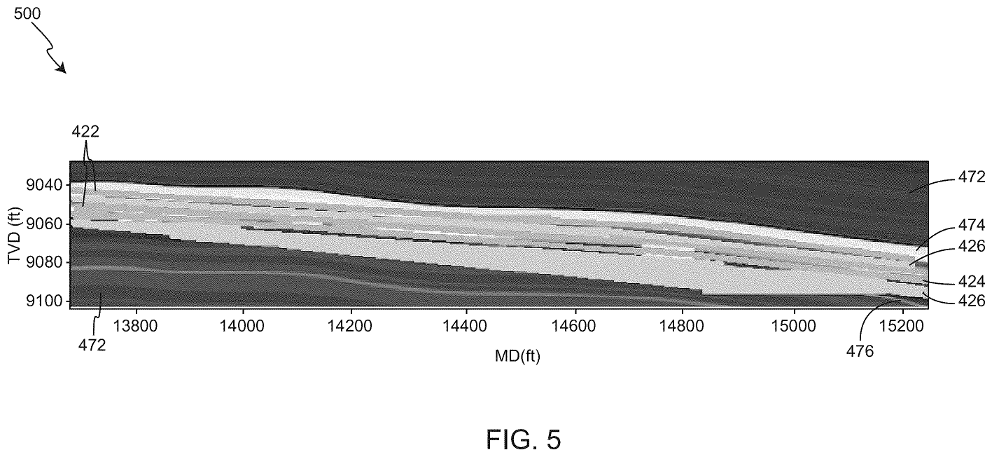

FIG. 5 illustrates another example of a clustering process that uses SOMs as the unsupervised machine learning clustering algorithm to provide an output of another visual representation according to the principles of the disclosure; and

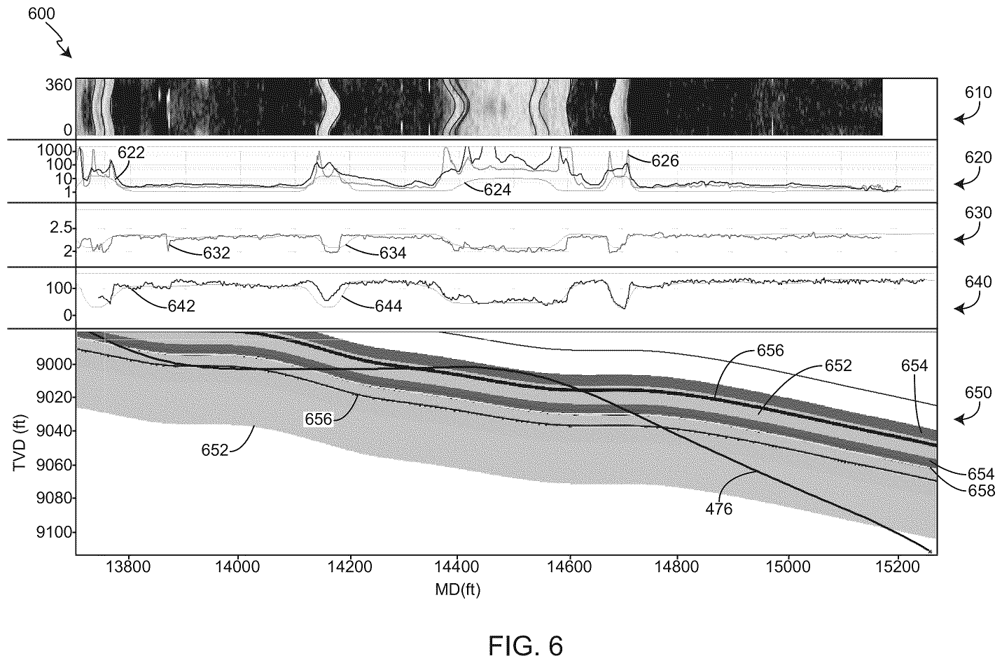

FIG. 6 illustrates yet another example of a clustering process that uses SOMs as the unsupervised machine learning clustering algorithm to provide an output that is yet another visual representation according to the principles of the disclosure.

### DETAILED DESCRIPTION

In geosteering and earth modelling, petrophysical log data is acquired in a target well by a LWD or MWD system and then manually correlated to petrophysical logs previously acquired in offset wells that has been projected onto the target well trajectory in the form of a pseudolog. The manual correlation is fundamentally based on the geologist's interpretation and accurate correlation with the offset well stratigraphy. As such, the correlation between a target well and an offset well can be interpreted in multiple different ways. For example, different faults can be invoked and lateral differences recognized or not recognized depending on the geologist doing the correlating. As such, correlations can be wrong or at least inconsistent since the correlations are highly interpretive.

Common pitfalls in the manual manipulation of the log data is that geologists make incorrect correlations between the well logs due to either sparse datasets, noise within the datasets, reservoir heterogeneity/complexity or erroneous a priori conceptual stratigraphic and structural maps. These noted challenges of manually correlating the petrophysical log data of a target well with one or more offset wells are present when the target well and the offset wells are vertical wells. Correlating the petrophysical log data, however, is even more challenging due to effects like anisotropy and lateral variation when the target well is a high angle or horizontal (HAHZ) well and the offset wells are vertical wells. For example, as a HAHZ well progresses layers are not necessarily changing but just the parameters are changing due to spatial variance.

One of the significant challenges with placement of HAHZ wells is the ability to identify wellbore positioning across discontinuous geology, such as faults. Identifying the stratigraphic position and facies type across fault zones requires the geologist currently to infer position from correlation of the multiple logs in order to infer the stratigraphic position either side of the fault. Where there is diagenetic or mineral changes associated with the fault zone this can complicate raw log curve interpretation.

One way to improve the correlation is by using more data. The more data sets, however, increases the difficulty of manually correlating and processing the data. Accordingly, an improved process for creating a geological model that can be used a target well, such as for geosteering a HAHZ well, would be beneficial in the industry.

The disclosure provides a data clustering process for interpreting formation data, such as delineating reservoirs in well placement models. The data clustering process can be used with correlating offset well data and HAHZ target well data. Facies distribution and thus stratigraphy and the position of a borehole within the stratigraphic setting can also be assessed using the data clustering process via unsupervised computer learning techniques.

A clustering process is a machine learning process of generating lower-dimensional representations of more complex higher order datasets using an unsupervised clustering algorithm. The unsupervised clustering algorithm can be, for example, Self-Organizing Maps (SOMs), Generative adversarial networks (GANS), or K-nearest neighbors. As used herein, a clustering process generates a facies cluster model of facies classification from petrophysical log data. Petrophysical log data or simply petrophysical data includes, for example, gamma-ray, resistivity, density, and porosity data. The clustering process includes two parts of training and mapping. The training generates a facies cluster model by applying an unsupervised competitive learning rule to find clusters within petrophysical datasets and the mapping calibrates the trained facies cluster model. The calibration can be via reference to a calibration curve (e.g. a facies log from an offset well) or automatically via hierarchical clustering. Hierarchical clustering allows grouping clusters based on their “distance” apart, i.e. the dissimilarity of the clusters.

The number of facies groups to be assigned for facies classification can be an input that is applied to the trained facies cluster model by a user. For example, a requested facies grouping can dictate a hierarchical cutoff. Hierarchical algorithms for grouping of the data can be, for example, (1) the minimization of the Euclidean distance or (2) the minimization of the within-cluster sum of squared Euclidean distance. Essentially this minimization of the within-cluster sum of squares looks to minimize the dispersion of the data within the cluster. Using SOM as an example, dendrograms and cluster group randomness plots can assist in visualizing where the cutoffs should be applied.

SOMs are an example of an unsupervised clustering algorithm that does not necessarily require a calibration dataset (although such data could be used.) SOMs can also work directly and accurately with uncorrected LWD or MWD curves making the technique useful in a real-time or recorded LWD/MWD environment. The SOMs can be Kohonen type SOMs based on square, hexagonal or spherical/toroidal node arrangements. FIGS. 4, 5, and 6 illustrate examples of a clustering process using SOMs as the unsupervised machine learning clustering algorithm.

Use of the disclosed clustering techniques can assist the geologist in understanding facies groups in various scenarios such as with HAHZ wells. The data can be interpreted in real-time or post well. The output from the facies clustering operation also provides the geologist with insights into lateral rock type distributions which are not necessarily obvious from simple log curve examination. The disclosed clustering process leads to improved visualization of LWD/MWD data through low dimensional understanding of higher-dimensional data, improved wellbore correlation between multiple boreholes and wellbore positioning automation workflows. Having generated the facies cluster models with respect to depth, the facies cluster models can be moved to the well placement or geosteering software for representation within a 2D or 3D visualization environment and used for performing well operations, such as drilling. Benefits of the disclosed data clustering approach for HAHZ target well data can include: identification of major geometrical tool effects and formation bed boundaries; identification of unique geological units, and; automated well log correlation.

Turning now to the figures, FIG. 1 illustrates an example of a well system 100 that is used to direct a drill bit to drill a wellbore (i.e., a target well) within a subterranean formation according to the principles of the disclosure. The system 100 is directed to drilling a wellbore on land for retrieving hydrocarbons, such as oil and gas, but the disclosed processes and systems can also be used to retrieve hydrocarbons from subsea locations. The disclosed processes and systems can also be used with other subterranean drilling applications including: geothermal wellbores, water wells, boreholes for mineral extraction, such as salts or brines, for placement of communications or power cables underground, or for placement of residential gas piping. Data from one or more offset well, referred to herein as offset well data, may be used by the well system 100 for drilling the target well. In FIG. 1, two offset wells, offset well 150 and offset well 160, are shown as examples.

The well system 100 includes a drilling platform 102 that supports a derrick 104 having a traveling block 106 for raising and lowering a drill string 108. A kelly 110 supports the drill string 108 as the drill string 108 is lowered through a rotary table 112. A top drive (not illustrated) can be used to rotate the drill string 108.

The well system 100 also includes a BHA 120 disposed in a directional borehole or wellbore 116 that extends into subterranean formation 101. As represented in FIG. 1, wellbore 116 is a HAHZ wellbore. The BHA 120 is a directional drilling BHA, which can include a mud motor a rotary steerable system or another type of direction drilling technology, and a drill bit 124 that is positioned at the downhole end of the BHA 120. Mud motor 121 is used with well system 100 as an example. The drill bit 124 may be driven by the mud motor 121 and/or rotation of the drill string 108 from the surface. As the drill bit 114 rotates, the drill bit 114 creates wellbore 116 that passes through various formation layers denoted by element number 105. A pump 130 circulates drilling fluid through a feed pipe 132 and downhole through the interior of drill string 108, through orifices in drill bit 124, back to the surface via annulus 118 around drill string 108, and into a retention pit 134. The drilling fluid transports cuttings from the wellbore 116 into the pit 134 and aids in maintaining the integrity of the wellbore 116.

The BHA 120 includes tools that collect drilling data including survey trajectory data, formation properties and various other drilling conditions as the drill bit 114 extends the wellbore 116 into the subterranean formation 101 to a desired well reservoir. The tools can include one or more LWD or MWD tools 126 that collect petrophysical measurements while drilling. The LWD/MWD tool 126 may include devices for measuring lithographic information such as formation resistivity and gamma ray intensity, devices for measuring the inclination and azimuth of the BHA 120, pressure sensors for measuring drilling fluid pressure, temperature sensors for measuring borehole temperature, or other sensors that collect petrophysical data.

The BHA 120 may also include a telemetry module 128. The telemetry module 128 receives measurements provided by various downhole sensors, e.g., sensors of the LWD/MWD tool 126, and transmits the measurements to a direction drilling system (DDS) 140. Similarly, data provided by the DDS 140 is received by the telemetry module 128 and transmitted to the BHA 120 and its tools, e.g., the LWD/MWD tool 126 and the mud motor 121. In some examples, mud pulse telemetry, wired drill pipe, acoustic telemetry, or other telemetry technologies known in the art may be used to provide communication between the DDS 140 and the telemetry module 128.

The mud motor 121 includes a housing 122 disposed about a steerable shaft 123. In this example, the steerable shaft 123 transfers rotation through the mud motor 121. A deflection or cam assembly surrounding the shaft 123 is rotatable within the housing 122 (which can be a rotation resistant housing) to orient the deflection or cam assembly such that the shaft 123 can be positioned in the borehole causing a change in trajectory. The mud motor 121 may include or be coupled to directional sensors (e.g., a magnetometer, gyroscope, accelerometer, etc.) for determination of its state, e.g., azimuth and inclination with respect to a reference direction and reference depth.

The mud motor 121 is configured to change the direction of the BHA 120 and/or the drill bit 124, based on control inputs, e.g., steering commands, from the DDS 140. The DDS 140 provides the steering commands based on a well plan for drilling the target well, wellbore 116. The DDS 140 can update the well plan based on a facies cluster model that is generated using a machine-learning clustering process on the petrophysical data from the wellbore 116 (i.e., target well data). Petrophysical data from one or more offset wells (i.e. offset well data), such as offset wells 150 and 160, can also be used. The well plan can be updated in real-time as the target well, wellbore 116, is being drilled. The DDS 140 can be, for example, DDS 200 of FIG. 2. It is understood that a portion of the functionality of the DDS 140 can be located in one or more places and is not limited to the surface or near the surface and may be located downhole, e.g., within the BHA 120 near the mud motor 121.

FIG. 2 illustrates a block diagram of an example of a DDS 200, such as DDS 140 in FIG. 1, which is constructed according to the principles of the disclosure. The DDS 200 directs the steering of a drill bit, such as drill bit 124, according to a well plan. The DDS 200 includes an automatic formation delineator (AFD) 210 and a drilling controller 220. Instead of being integrated with the DDS 200, the AFD 210 can be located in another computing system that is communicatively coupled to the DDS 200. One skilled in the art will understood that although not shown, the DDS 200 may include other components of a directional drilling system.

The AFD 210 is configured to automatically process and categorize target well data using a clustering process for generating a facies cluster model of a subterranean formation. The AFD 210 can generate the facies cluster model using offset well data with the target well data. The target well can be an HAHZ well. A well operation can then be carried out using the facies cluster model, such as updating a geological model and a well plan that can be used for directional drilling. The AFD 210 includes one or more processors, represented by processor 212, an interface 214, and a memory 216 that are communicatively connected to one another using conventional means. The drilling controller 220 can also include one or more interface, one or more processors, and one or more memory. Either the AFD 210, the drilling controller 220, or both can also include a screen to provide a visual representation of the facies cluster model, such as provided as an output in step 340 of method 300 of FIG. 3.

The processor 212 is configured to automatically determine the facies cluster model using a clustering process for the target well data. In addition to the target well data, offset well data can also be used. The updated well plan can be provided to the drilling controller 220 for making steering decisions. The processor 212 can operate according to an algorithm corresponding to at least some of the steps of the method 300 in FIG. 3. The algorithm can be an unsupervised machine learning algorithm for clustering and can be represented as a series of operating instructions stored on the memory 216.

The processor 212 may be any data processing unit, such as a central processing unit, a graphics processing unit, and/or a hardware accelerator. It is understood that the number of processors and the configuration that can be used for the AFD 210 is not limited as illustrated. For example, multiple processors can be used for the AFD 210. Additionally, the functionality of the AFD 210 can be distributed to processors at different locations, including a data center or a corporate office.

The interface 214 receives and transmits data for the AFD 210. The interface 214 forwards the received data to the processor 212 or the memory 216. For example, the interface 214 receives petrophysical data from the target well and the offset well. The target well data can be received in real-time during drilling of the target well. The target well data can be from real-time sensor measurements (e.g., survey data) from various downhole sensors, such as sensors of a MWD or LWD tool and/or directional sensors. The sensors can include, for example, at least one of gamma-ray sensors, resistivity sensors, density sensors, porosity sensors, drilling dynamic sensors, acoustic sensors, or nuclear magnetic resonance sensors. A combination of the different type of sensors can also be used. The offset well data, such as petrophysical data from one or more of offset wells 150 and 160, can be historical data from a database or other data storage device. The offset well data may be stored on the memory 216.

The interface 214 also transmits results of the clustering process based on the facies cluster model generated by the AFD 210. As illustrated in FIG. 2, the results, or output, can be an updated well plan, a visual representation of the facies cluster model, or a combination of both. Facies clusters of the facies cluster model could then be visualized within 2 dimensional or 3 dimensional geosteering or well placement software or even interpolated in either 2 or 3 dimensions to aid well placement and identification of stratigraphic position or as an input for net-to-gross or other petrophysical and geological parameter calculations. In scenarios where rapid geological lateral variation occurs, the facies cluster model identifies these units as unique formations not previously encountered within the offset well or target well datasets indicating to the operator that a lateral variation has been encountered. The interface 214 transmits the output to a well system that can use the output for execution of a well operation. In FIG. 2, for example, the output is sent to drilling controller 220. The interface 214 may be implemented using conventional circuitry and/or logic.

This data could then be visualized within 2 dimensional or 3 dimensional geosteering or well placement software as shown in FIG. 2 or even interpolated in either 2 or 3 dimensions as shown in FIG. 3 to aid well placement or as an input for net-to-gross or other petrophysical and geological parameter calculations

The memory 216 can be a non-transitory memory that stores data, e.g., real-time sensor measurements and historical data, which is needed in performing the disclosed methodology, e.g., method 300 of FIG. 3. The memory 216 also store a series of instructions that when executed, causes the processor 212 to perform the disclosed methodology. The memory 216 may be a conventional memory device such as flash memory, ROM, PROM, EPROM, EEPROM, DRAM, SRAM and etc.

The drilling controller 220 generates steering commands for operating a drill bit. The drilling controller 220 can be a conventional controller that sends the steering commands to a BHA or drill bit for directing a drilling operation, such as drilling HAHZ wellbore 116. The drilling controller 220 can automatically generate and send the steering commands based on an output from the AFD 210. Additionally, the drilling controller 220 can receive manual inputs based on an output from the AFD 210, such as a visual representation, to generate steering commands.

FIG. 3 illustrates a flow diagram of an example of a method 300 of performing a well operation carried out according to the principles of the disclosure. Method 300 includes generating and using a facies cluster model for a well operation associated with a well, such as HAHZ wellbore 116 of FIG. 1. Target well data and offset well data can be used for generating the facies cluster model. At least some of the steps of method 300 can be performed by an AFD, such as AFD 210. The method 300 can assist in the automation of wellbore placement revealing correlations between target well data that are typically unobserved by manual interpretation. The method can assist in the visualization of reservoirs and geological structures ultimately improving reservoir insight and overall well placement. Method 300 starts in step 305.

In step 310, offset well data is obtained from at least one offset well. Offset wells are preferably chosen in the same vicinity of the target well and/or selected due to having similar formation characteristics. Offset well 150 and/or offset well 160 of FIG. 1 provide examples. The offset well data can be stored in and retrieved from a database that is either proximate or remote from the target well. The offset well data can be stored in, for example, a memory of a DDS, such as in memory 216 of AFD 210. When multiple offset wells are used, the data can be combined for each specific type of drilling data and used as a single representation of the offset wells. Interpolation and kriging can be used to combine the offset well data from different offset wells.

The offset well data can be from data logs corresponding to sensor measurements collected while drilling the offset well. The sensor measurements may include but are not limited to gamma-ray, resistivity, density, and porosity. The offset well data can be stored as raw data that needs to be analyzed and processed (e.g., preprocessed) before being used in method 300 to interpret target well data.

In step 320, target well data is obtained. The target well data can be obtained in real-time as the target well is being drilled. The real-time data includes different types of petrophysical data and can be obtained from sensors, such as LWD sensors, MWD sensors, or other types of sensors associated with obtaining measurements during drilling. The different types of petrophysical data obtained for the target well can correspond to the types of petrophysical data from the offset well data. As with the offset well data, the target well data can be stored as raw data that needs to be processed (e.g., preprocessed) before being used in method 300. The processing can include one or more of the different types of processing that is performed on the offset well data, such as filtering, smoothing, or other types of data processing that can be used to clean (e.g., remove noise) the target well data.

A facies cluster model is generated in step 330. The facies cluster model provides facies classifications with respect to the subterranean formation. The facies cluster model is generated using a clustering process on the target well data for classifying facies into clusters. Generating the facies cluster model includes categorizing the target well data using a machine learning model that is trained using the clustering process. Generating the facies cluster model can include correlating the target well data with offset well data. For example, the target well data that is received can be compared to the trained facies cluster model for determining the type of facies. Method 300 can operate using the target well data without the offset well data and simply train a facies cluster model as the target well data is received. With offset well data, a facies cluster model can be trained before drilling of the target well begins and then updated when the target well data is received. The target well data can be received in batches or continuously streamed; both can be automatic.

In step 340, an output based on the facies cluster model is provided. The output can be an updated well plan. The output can be a visual representation of the facies cluster model. Various types of visual representations based on the facies cluster model can be provided. The different facies clusters can be represented, for example, by colors, numbers, symbols, etc., and can be combined with other subterranean formation data in a visual display. FIGS. 4, 5, and 6 provide examples of different visual representations that can be output. The output or outputs can be provided to other well systems for additional processing and implementation. For example, the outputs can be provided to one or more different well systems such as a DDS or a drilling controller.

In step 350, a well operation associated with the wellbore is performed based on the facies cluster model. The well operation can be performed based on one more outputs of the method 300. The well operation can be drilling the wellbore and includes steering a drill bit using the facies cluster model. Steering the drill bit can be automatically performed. Steering the drill bit can also be manually controlled by an operator using the visual representation. Performing the well operation can include modifying a well plan (i.e., a geological model around wellbore) for the wellbore using the facies cluster model. The updated well plan can then be used for steering the drill bit in an automated workflow. This can be done manually or automatically. The method 300 continues to step 360 and ends.

As noted above, different unsupervised clustering algorithms can be used for generating the facies cluster models. FIGS. 4, 5, and 6 illustrate examples of generating facies cluster models that are facies clusters with respect to depth using SOMs. Because of the high borehole inclination combined with the general nature of sedimentary basin deposition it is normal for only small groups of disparate facies types to be encountered. This means that SOMs are well suited to the problem of identifying these clusters. Additionally SOMs cope well with limited sparse data as is the scenario in geosteering and well placement work. The facies clusters can be moved to well placement or geosteering software for representation within the 2D or 3D visualization environment as shown in FIGS. 4, 5, and 6 to aid well placement or as an input for net-to-gross or other petrophysical and geological parameter calculations.

FIGS. 4, 5, and 6 provide examples of visual representations than can be generated and used. Other visual representations can be generated, such as color coding a well path or using blocks having facies numbers. The visual representations can be used to support a geologist's manual interpretation of the subterranean formation or provide an alternative interpretation that does not support the manual interpretation and indicate changes should be made to, for example, the well plan.

FIG. 4 visually illustrates an example of a clustering process 400 that uses SOMs as the unsupervised machine learning clustering algorithm to provide an output that is a visual representation 470 according to the principles of the disclosure. The visual representation 470 includes SOM facies clusters represented by different boxes that are applied in 3D space along a target wellbore, which is an HAHZ wellbore in this example, within an existing 3D well placement modelling software. The diagram depicts a 2D cut through the geological structure flattened against the wellbore azimuth.

The clustering process 400 begins with obtaining target well data in real-time as represented by the tracks and traces of FIG. 4. Target well data 410 is an image log of raw resistivity data collected from around (zero to 360 degrees) the HAHZ wellbore in real-time by a resistivity tool. Traces 430, 440, 450, and 460 also include target well data collected in real-time from the HAHZ wellbore. In traces 430, 440, 450, and 460, the target well data is displayed as solid lines. Trace 430 includes high-side oriented ratio signals, denoted as curve 432 and curve 434, from a deep directional resistivity tool that measures resistivity at different angles around a borehole. The curves represent the ratio between the resistivity on the high-side of the HAHZ wellbore and the average of all the resistivity values around the HAHZ wellbore. The curves 432, 434, are therefore unitless ratios and indicate the relative direction of increased conductivity. Curve 432 represents the 112″ 125 kHz phase resistivity ratio and curve 434 represents the 96″ 500 kHz phase resistivity ratio as examples. Other ratio curves can be used.

Trace 440 includes resistivity data that is a plot of sub-segments of the resistivity data of image log 410. 360 degree resistivity data is denoted by element 442 and 180 degree resistivity data is denoted by element 444. Resistivity data is also included in trace 450 and is plotted as an average of all of the bin segments of the resistivity data of image log 410. Trace 460 includes target well data that is gamma ray data.

Traces 430, 450 and 460 also include model based pseudologs of corresponding offset well data projected onto the respective target well data of each of the traces 430, 450, and 460. The pseudolog datasets are displayed as dashed lines in traces 430, 450, and 460. In trace 430 1D forward modelled simulated curves corresponding to the same frequencies and spacings used for the curves 432 and 434 are shown as dashed lines, wherein simulated curve 436 corresponds to curve 432 and simulated curve 438 corresponds to curve 434. The forward model curves 436, 438, from the deep resistivity tool can be ultimately derived from the geological model and well trajectory 476 shown in the visual representation 470 and the pseudolog curve (the dashed line) shown in trace 450. In trace 440 simulated forward model responses 446 and 448 are shown as dashed lines. The forward model simulations 446 and 448 are based on the deep directional resistivity tool that measures resistivity at different angles around a borehole. The forward model simulations 446 and 448 correspond to biaxial angles of 180 and 360 degrees and use the offset pseudolog resistivity model values represented by the dashed line shown in track 450 as its input curve.

A facies cluster model 420 is generated from the target well data and the offset well data of traces 410 and 430 to 460. The facies cluster model 420 includes three different facies types that have been classified according to the clustering process using SOM as the clustering algorithm. The different types of facies 422, 424, and 426 are denoted in the facies cluster model 420 and also denoted in the visual representation 470.

The visual representation 470 includes a projected model having different facies layers, such as shale 472 and two thin layers of sand 474 located in between. The projected model was generated from the offset well data shown in traces 430 to 460. Three different types of facies clusters of the facies cluster model 420 are applied on the projected model, facies type 422, 424, and 426, and are identified in the visual representation 470. As seen in FIG. 4, the different facies types identified via the facies cluster model differ from the projected model. Well path 476 of the HAHZ wellbore is also identified in the visual representation. For the geological model and facies model of FIG. 4, the X-axis is measured depth (can also be total horizontal length or similar) while the Y-axis is total vertical depth (either below rotary table, or subsea.) The measured depths and vertical depths can be measured, for example, in feet or meters. For the image log 410, the Y axis is from zero to three hundred and sixty degrees. The Z-axis color map of the visual representation 470 can either be a model based projection of an offset well log parameter (e.g. gamma ray, resistivity, density, velocity etc.) or a geostatistically simulated or kriged property model. The overlaying facies map can be an arbitrarily colored facies model 2D map, which potentially could also be a 2D projection of a 3D facies map as well.

FIG. 5 illustrates another example of a visual representation 500 from the clustering process 400. In contrast to visual representation 470, in visual representation 500 each of the same facies clusters 422, 424, and 426 are joined together to show laterally continuous clusters as a different way to visualize a facies cluster model as an output.

FIG. 6 visually illustrates an example of using clustering process 400 to update the model of the HAHZ target wellbore and provide an output that is a visual representation 650 according to the principles of the disclosure. The model represented in the visual representation 500 is used to update the model of the HAHZ target wellbore. The updating process can be performed automatically. Target well data collected in real-time and offset pseudologs based on the updated model are reflected in the tracks and traces of FIG. 6.

Image track 610 is an image log of raw resistivity data collected from around (zero to 360 degrees) the HAHZ wellbore in real-time by a resistivity tool. Resistivity data is also included in trace 620 and is plotted as an average of all of the bin segments of the resistivity data of image track log 610. The average resistivity data is denoted in trace 620 by element 622. Trace 630 includes target well data that represents the bottom quadrant (or “low-side”) bulk density measurement of the HAHZ wellbore and is denoted by element 632. Trace 640 includes target well data that is gamma ray data that is denoted by element 642.

Traces 620, 630, 640, also include the corresponding offset data pseudologs derived from the updated model of FIG. 5. The offset pseudologs are denoted as 624, 634, and 644, respectively. Trace 620 also includes a forward model simulation denoted as 626 that is based on the deep directional resistivity tool also used for the forward model simulations 446 and 448 of FIG. 4.

The visual representation 650 corresponds to an additional processing step following the SOM and clustering that can allow more complete automation of the process. After the facies cluster model has been constrained based on use of the SOM and data clustering, a gradient descent curve fitting algorithm can be employed in order to locally match the target well curve data (either azimuthally focused or bulk measurement) to the projected pseudolog curve. The additional processing step does not necessarily consider any compensation for geometrical tool responses associated with anisotropy or adjacent bedding which have contributed to the results of the initial SOM and clustering step.

The specific algorithm used for the local curve fitting optimization problem can vary. A measured depth window for the local curve fitting optimization could be based on the results of the SOM clustering step since it would be required that the curve matching be highly localized. The output of the curve fitting would result in the type of geological model shown as the visual representation 650, which shows the matching of target well data with the pseudolog curve data constrained by the SOM facies indicators in geological cross section.

The geological model of the visual representation 650 was generated from the offset well pseudo logs shown in traces 620 to 640 and includes unique facies clusters that were not captured by the geological model of visual representation 470 but were detected by the SOM process represented in FIGS. 4 and 5. The model of the visual representation 650 includes different facies layers, such as shale 652 and two thin layers of sand 654 that correspond to the shale and sand layers 472 and 474 of the geological model of the visual representation 470. Two additional different types of facies layers are also include via the SOM process, facies layers 656 and facies layer 658. Projected well path 476 of the HAHZ wellbore is also identified. The X and Y axis of FIG. 6 correspond to the X and Y axis of FIG. 4 and FIG. 5.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

As noted in the Summary aspects disclosed herein include:

A method including: (1) obtaining target well data from a wellbore in a subterranean formation, (2) generating a facies cluster model for the subterranean formation using a clustering process on the target well data, and (3) performing a well operation associated with the wellbore using the facies cluster model.

An automated directional drilling system including: (1) obtaining target well data from a high angle or horizontal (HAHZ) wellbore in a subterranean formation, (2) generating a facies cluster model for the subterranean formation using a clustering process on the target well data, and (3) drilling the HAHZ wellbore steering a drill bit in the subterranean formation using the facies cluster model.

A computer program product having a series of operating instructions stored on a non-transitory computer readable medium that direct operation of one or more processors when initiated thereby to perform operations including: (1) receiving target well data from a wellbore in a subterranean formation, (2) automatically generating a facies cluster model for the subterranean formation using a clustering process on the target well data, and (3) directing a well operation associated with the wellbore using the facies cluster model.

Each of the disclosed in aspects A, B, and C can have one or more of the following additional elements in combination. Element 1: wherein the wellbore is a high angle or horizontal (HAHZ) wellbore. Element 2: wherein the clustering process is a machine learning process that uses an unsupervised clustering algorithm on the target well data. Element 3: wherein the unsupervised clustering algorithm is selected from the group consisting of Self-Organizing Maps, Generative adversarial networks, and K-nearest neighbors. Element 4: wherein the well operation is drilling the wellbore and includes steering a drill bit using the facies cluster model. Element 5: wherein steering the drill bit is performed automatically. Element 6: further comprising providing a visual representation of the facies cluster model and manually performing the well operation using the visual representation. Element 7: wherein generating the facies cluster model includes correlating the target well data with offset well data. Element 8: wherein the obtaining, the generating, and the performing are carried out in real-time. Element 9: wherein the generating includes categorizing the target well data using a machine learning model that is trained using the clustering process. Element 10: wherein performing the well operation includes modifying a well plan for the wellbore using the facies cluster model. Element 11: wherein the clustering process is a machine learning process that uses an unsupervised clustering algorithm on the target well data. Element 12: wherein the unsupervised clustering algorithm is Self-Organizing Maps. Element 13: the operations further include providing a visual representation of the facies cluster model. Element 14: wherein generating the facies cluster model includes correlating the target well data with offset well data. Element 15: wherein the generating is carried out in real-time. Element 16: wherein the generating includes categorizing the target well data using a machine learning model that is trained using the clustering process. Element 17: wherein the wellbore is a high angle or horizontal (HAHZ) wellbore and the well operation is drilling the wellbore by steering a drill bit using the facies cluster model.

What is claimed is:

1. A method of performing a well operation associated with a wellbore, comprising:
obtaining target well data from a wellbore in a subterranean formation;
generating a facies cluster model for the subterranean formation using a clustering process on the target well data; and
performing a well operation associated with the wellbore using the facies cluster model.

2. The method as recited in claim 1, wherein the wellbore is a high angle or horizontal (HAHZ) wellbore.

3. The method as recited in claim 1, wherein the clustering process is a machine learning process that uses an unsupervised clustering algorithm on the target well data.

4. The method as recited in claim 3, wherein the unsupervised clustering algorithm is selected from the group consisting of Self-Organizing Maps, Generative adversarial networks, and K-nearest neighbors.

5. The method as recited in claim 1, wherein the well operation is drilling the wellbore and includes steering a drill bit using the facies cluster model.

6. The method as recited in claim 5, wherein steering the drill bit is performed automatically.

7. The method as recited in claim 1, further comprising providing a visual representation of the facies cluster model and manually performing the well operation using the visual representation.

8. The method as recited in claim 1, wherein generating the facies cluster model includes correlating the target well data with offset well data.

9. The method as recited in claim 1, wherein the obtaining, the generating, and the performing are carried out in real-time.

10. The method as recited in claim 1, wherein the generating includes categorizing the target well data using a machine learning model that is trained using the clustering process.

11. The method as recited in in claim 1, wherein performing the well operation includes modifying a well plan for the wellbore using the facies cluster model.

12. An automated directional drilling system, comprising:
one or more processors to perform operations including:
generating a facies cluster model for a subterranean formation using a clustering process on target well data from a high angle or horizontal (HAHZ) wellbore in the subterranean formation; and
drilling the HAHZ wellbore by steering a drill bit in the subterranean formation using the facies cluster model.

13. The automated directional drilling system as recited in claim 12, wherein the clustering process is a machine learning process that uses an unsupervised clustering algorithm on the target well data.

14. The automated directional drilling system as recited in claim 13, wherein the unsupervised clustering algorithm is Self-Organizing Maps.

15. The automated directional drilling system as recited in claim 12, the operations further include providing a visual representation of the facies cluster model.

16. The automated directional drilling system as recited in claim 12, wherein generating the facies cluster model includes correlating the target well data with offset well data.

17. The automated directional drilling system as recited in claim 12, wherein the generating is carried out in real-time.

18. The automated directional drilling system as recited in claim 12, wherein the generating includes categorizing the target well data using a machine learning model that is trained using the clustering process.

19. A computer program product having a series of operating instructions stored on a non-transitory computer readable medium that direct operation of one or more processors when initiated thereby to perform operations in real-time comprising:
automatically generating a facies cluster model for a subterranean formation using a clustering process on target well data from a wellbore in the subterranean formation; and
directing a well operation associated with the wellbore using the facies cluster model.

20. The computer program product as recited in claim 19, wherein the wellbore is a high angle or horizontal (HAHZ) wellbore and the well operation is drilling the wellbore by steering a drill bit using the facies cluster model.
